(19) United States
(12) Patent Application Publication
(10) Pub. No.: US 2019/0242727 A1
(43) Pub. Date: Aug. 8, 2019

(54) CAPACITIVE PROXIMITY SENSOR

(71) Applicant: BROSE FAHRZEUGTEILE GMBH & CO. KOMMANDITGESELLSCHAFT, BAMBERG, Bamberg (DE)

(72) Inventors: Bernd HERTHAN, Michelau (DE); Stefan HIELTSCHER, Bamberg (DE); Markus KORDER, Ebensfeld (DE); Florian POHL, Ebersdorf (DE); Thomas WEINGAERTNER, Memmelsdorf (DE)

(73) Assignee: BROSE FAHRZEUGTEILE GMBH & CO. KOMMANDITGESELLSCHAFT, BAMBERG, Bamberg (DE)

(21) Appl. No.: 16/335,478

(22) PCT Filed: Sep. 20, 2017
(86) PCT No.: PCT/EP2017/073833

§ 371 Date: Mar. 21, 2019

(30) Foreign Application Priority Data
Sep. 21, 2016 (DE) 102016218179.3

(51) Int. Cl. G01D 5/24; B60R 16/03

(52) U.S. Cl. CPC G01D 5/24; B60R 16/03

(57) ABSTRACT

A method of producing a proximity sensor, comprising integrating an electrode carrier with an electronics housing, forming an electronic housing via plastic injection moulding, embedding at least one capacitive sensor electrode into the electrode carrier, arranging a sensor electronics system in the electronics housing of the electrode carrier and inside the electronics housing, wherein the sensor electronic system is contact-connected to at least one capacitive sensor electrode, and supplying energy to the sensor electronic systems utilizing a plug element, wherein the plug element is configured to serve for contact connection to an energy source provided by the motor vehicle, wherein the energy source is produced separately from the electrode carrier.

### CROSS-REFERENCE TO RELATED APPLICATIONS

This application is the U.S. National Phase of PCT/EP2017/073833 filed Sep. 20, 2017, which claims priority to German Patent Application No. DE 10 2016 218 179.3 filed Sep. 21, 2016, the entire disclosures of which are incorporated by reference herein.

### TECHNICAL FIELD

The disclosure relates to a production method for a capacitive proximity sensor, which is configured and provided for use in a motor vehicle. The disclosure furthermore relates to such a capacitive proximity sensor.

### BACKGROUND

Proximity sensors, which are formed, in particular, of a sensitive element and an associated controller (also referred to as control and evaluation unit), are often used in motor vehicles. Such proximity sensors are used, for example, to detect the distance between a person or an object regarded as an obstacle and the motor vehicle or a vehicle part of said motor vehicle moved by way of motor. In this case, such proximity sensors are used, for example, in the context of (in particular contactless) jamming or collision protection for vehicle doors and/or window panes that are moved by way of motor. Furthermore, proximity sensors are also used to detect an approach event, for example a movement of a body part of a vehicle user and to derive therefrom, for example, a desire of the vehicle user to open a door. The operator control of the corresponding vehicle door may thereby be made easier for a vehicle user who, for example, does not have a free hand for the operator control of the corresponding vehicle door or a switch of a remote operator control system serving to actuate the vehicle door.

In conventional proximity sensors, the controller is usually inserted into an associated housing and tightly enclosed thereby. For the contact connection of the controller to an energy supply of the motor vehicle, a plug connector is in this case integrally incorporated in the housing. This makes on the one hand simple sealing and also a reduction in the number of parts possible, which each contribute to decreasing the mounting outlay. Since such proximity sensors are being used in an increasing number of vehicle models, it is often necessary to adapt the plug connector to a mating plug used in the corresponding vehicle model (in particular for the on-board power supply system thereof). As a result, the manufacturing costs are increased in turn since—in particular in the case of housings that are injection-molded from plastic—various injection-molding tools have to be manufactured and kept available for the adapted housing.

### SUMMARY

The disclosure is based on the object of specifying a capacitive proximity sensor that may be produced in a cost-effective manner.

This object is achieved according to the disclosure by way of a production method for a capacitive proximity sensor having the features described below. The object is also achieved according to the disclosure by way of a capacitive proximity sensor having the features of other embodiments described below. Further embodiments and further developments of the disclosure that are advantageous and, in some cases, inventive in themselves are presented in other embodiments and also in the following description.

The production method according to the disclosure serves for the manufacture of a capacitive proximity sensor for a motor vehicle. In the context of this production method, an electrode carrier having an electronics housing (also referred to as an “electronics recess”) integrated therein is formed from plastic by injection molding. At least one capacitive sensor electrode is embedded into said electrode carrier. A sensor electronics system is then arranged in the electronics housing of the electrode carrier and inside the electronics housing is contact-connected such as directly) to the or the respective sensor electrode.

Furthermore, a plug element, which serves to supply energy to the sensor electronics system and thereby may serve for contact connection to an energy source provided by the motor vehicle, is produced separately from the electrode carrier (and therefore preferably also separately from the electronics housing). That is to say said plug element may not form part of the electrode carrier described above. The sensor electronics system is in this case contact-connected to said plug element utilizing an associated energy supply line (preferably contact-connected directly to the sensor electronics system).

The capacitive proximity sensor according to the disclosure serves for use in a motor vehicle. The capacitive proximity sensor may be manufactured according to the production method described above. In other words, the capacitive proximity sensor (referred to in the following text in short only as proximity sensor) comprises the or the respective (above-described) capacitive sensor electrode, the sensor electronics system and the electrode carrier in which the electronics housing described above is integrally formed and into which the or the respective sensor electrode is embedded. The sensor electronics system is in this case arranged in the electronics housing and inside said electronics housing is contact-connected (which may be connected in a signal-transmitting manner) to the sensor electrode. The energy supply line of the sensor electronics system is in this case fed onto the plug element (described above) produced separately from the electrode carrier.

The handling of the proximity sensor during mounting is simplified by integrating the electronics housing, in particular in the form of an electronics recess formed in the electrode carrier in a trough-like manner and forming in this case a housing shell for the sensor electronics system, into the electrode carrier and embedding the sensor electrodes into the electrode carrier. Furthermore, the manufacture of the proximity sensor is also simplified since the total number of (individual) components is advantageously reduced. Since the electrode carrier is injection-molded from a plastic (for example a thermoplastic) and the or the respective sensor electrode is embedded into the electrode carrier during the injection-molding process, the fluid-tightness of the proximity sensor may also advantageously be increased with a low mounting outlay.

Moreover, as a result of the fact that the plug element may be produced separately from the electrode carrier, the latter may advantageously be used as a standard component for a multiplicity of proximity sensors used in various vehicle models (possibly also from different manufacturers). As a result, production costs may be kept low since one and the same tool may be used to produce the electrode carrier for a multiplicity of proximity sensors that are adapted to different vehicle models.

The sensor electronics system may form a control and evaluation unit, also referred to as a “controller”, of the proximity sensor, in which the measurement signals generated by the or the respective sensor electrode are evaluated during operation of the proximity sensor. In one embodiment, the sensor electronics system comprises here a microcontroller having a processor and a data memory, in which the functionality for evaluating the detected measurement signals is implemented in terms of programming in the form of operating software (firmware). In the context of the disclosure, the sensor electronics system may alternatively also, however, be formed by a non-programmable electronic component, for example an ASIC.

In both variants, the sensor electronics system may also include a printed circuit board (PCB for short), on which the electronic components described above are arranged.

In one embodiment, the energy supply line described above may also include a data line, which may serve for the transmission of the sensor data generated by the sensor electronics system during evaluation of the measurement signals to a superordinate “on-board electronics system” of the motor vehicle.

In an embodiment that is expedient with respect to the fluid-tightness of the proximity sensor, exclusively the or the respective sensor electrode may pass through a wall of the electrode carrier that forms a part of the wall of the electronics housing. Since the or the respective sensor electrode may be integrated (embedded) into the electrode carrier by injection molding and therefore already effectively sealed off in the region of the entry thereof into the electronics housing (into the electronics recess), the sealing outlay of the proximity sensor may advantageously be kept particularly low. Furthermore, an injection-molding tool used for the injection-molding manufacture of the electrode carrier may be designed in a simple and therefore comparatively cost-effective manner.

In an expedient embodiment, the plug element is embodied, in particular, in one piece (that is to say monolithically) with a cover, by way of which the electronics housing (in the final mounting state as intended) is sealed. The energy supply line may also be fed through a line feedthrough, which is arranged in the cover, to the plug element. In this embodiment, only the cover (produced, in particular, separately from the electrode carrier) for the electronics housing therefore needs to be adapted to the shaping of the plug element required in the specific use of the proximity sensor.

Particularly for the case where the plug element is integrated into the cover of the electronics housing, the energy supply line may be formed in an expedient embodiment by one conductor track or, in particular, a plurality of conductor tracks arranged on a printed circuit board. Said printed circuit board may be integrated into the cover by injection molding here in such a way that the conductor tracks of said printed circuit board are contact-connected to respectively associated plug contacts (for example contact pins). In the mounted state as intended, the conductor tracks of said printed circuit board are contact-connected to the sensor electronics system.

In an alternative embodiment, the plug contacts mentioned above are fed through the cover and in the final mounted state as intended may be contact-connected directly to the sensor electronics system.

In a further expedient embodiment, in particular in a premounted state as intended, the sensor electronics system is secured to the cover (and may be contact-connected to the above-described plug contacts of the plug element integrated into the cover). In this case, the sensor electronics system may include a contact configured to automatically contact-connect the sensor electronics system to the sensor electrode or the respective sensor electrode during mounting of the cover on the electrode carrier. In such an embodiment, the sensor electrode or the respective sensor electrode may be contact-connected to the sensor electronics system by using the contact means described above during mounting of the cover. The contacts are, for example, insulation displacement contacts, contact springs, clamping contacts and the like, which make automatic and, in this case, captive contact connection possible. As a result, the mounting of the proximity sensor is further simplified since separate contact connection of the or the respective sensor electrode to the sensor electronics system takes place, in particular, automatically, that is to say without separate assistance.

In a further expedient embodiment that forms an alternative to the plug element integrated into the cover, the energy supply line (and also the data line possibly contained therein), in particular in the form of a cable, is fed through a wall element of the electronics housing to an outer side of the electrode carrier. Said wall element, for example, is the (in particular separately produced) cover described above or optionally a wall of the electrode carrier itself. The energy supply line is connected here to the separately produced plug element in the region of the outer side of the electrode carrier. One advantage of this embodiment is that, depending on the location where the proximity sensor is used and/or depending on the vehicle model, the length of the energy supply line may be varied in a simple manner in order to make it possible to connect the sensor electronics system to the on-board power supply system, in particular to a “cable harness” of the motor vehicle, in a simple manner. Furthermore, only the separate plug element needs to be adapted to a mating piece provided by the corresponding vehicle model.

In another embodiment of this disclosure, the plug element is not secured here to the electrode carrier or to the cover, but instead is arranged in a manner freely suspended on the energy supply line. As a result, the energy supply line may be fed in a simple manner to the above-described cable harness of the motor vehicle.

In another embodiment (as an alternative to the freely suspended plug element), the plug element may be secured (optionally in a releasable manner) to a surface of the electrode carrier, in particular on the top side or bottom side thereof. For example, the plug element may be clipped onto the electrode carrier, screwed thereto, welded or adhesively bonded thereto.

In another embodiment, the electrode carrier in this case has a multiplicity of receiving positions for the plug element. As a result, as described above, the position of the plug element on the electrode carrier may advantageously be varied and therefore adapted to the connection circumstances of the respective vehicle model by adapting the length of the energy supply line. The different receiving positions are realized in this case, for example, in each case by clips integrally formed on the electrode carrier, into which clips the plug element may be clipped, or alternatively by depressions for receiving such clips. For example, the electrode carrier has “rail-like” grooves, into which the plug element may be clipped or “hooked” in a particularly variable manner with respect to the position of said plug element on the electrode carrier.

### BRIEF DESCRIPTION OF THE DRAWINGS

Exemplary embodiments of the disclosure are illustrated in more detail below with reference to a drawing, in which:

FIG. 1 shows a schematic plan view of a capacitive proximity sensor in a premounted state,

FIG. 2 shows a longitudinal section of the capacitive proximity sensor according to FIG. 1 in the premounted state as intended,

FIG. 3 shows a view according to FIG. 2 of the proximity sensor in a final mounted state as intended,

FIG. 4 shows a view according to FIG. 2 of an alternative exemplary embodiment of the capacitive proximity sensor in the final mounted state as intended, and

FIG. 5 again shows a view according to FIG. 2 of a further exemplary embodiment of the capacitive proximity sensor in the final mounted state as intended.

Mutually corresponding parts may be provided with identical reference signs in all the figures.

### DETAILED DESCRIPTION

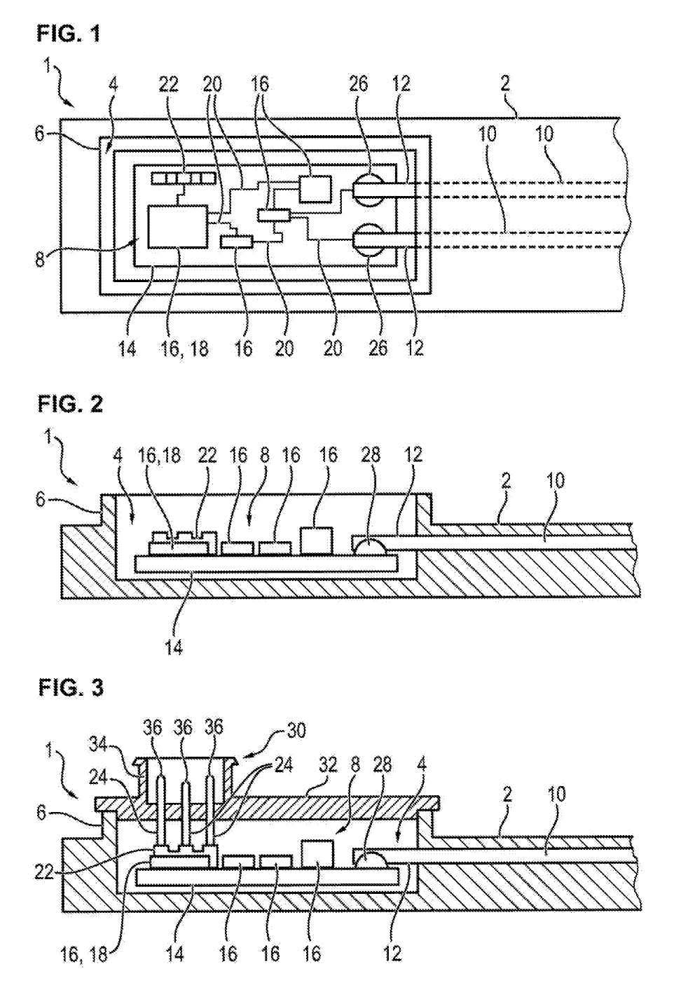

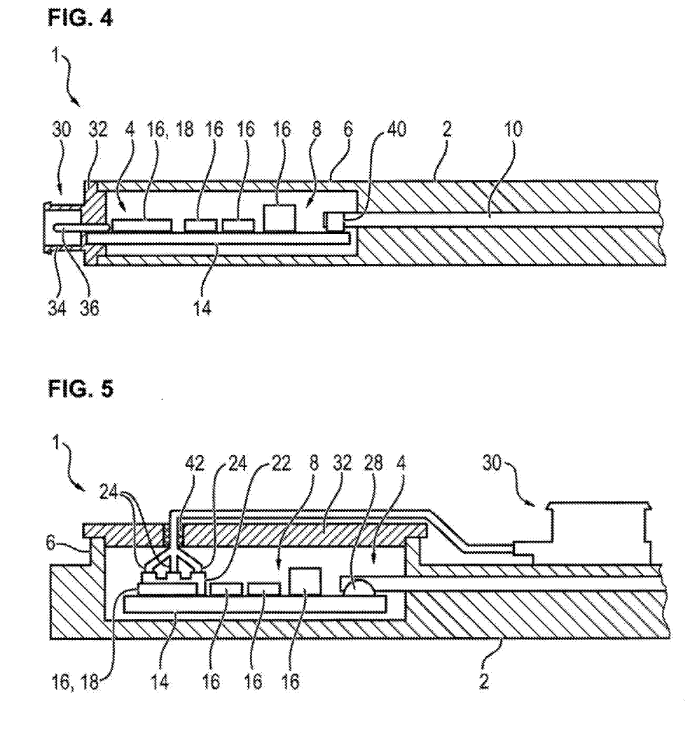

FIG. 1 schematically illustrates a capacitive proximity sensor 1. The proximity sensor 1 comprises an electrode carrier 2 formed in a substantially plate-like manner, in which an electronics housing in the form of a trough (referred to as “electronics recess 4”) is integrally incorporated. Said electronics recess 4 is bordered in an annularly enclosed manner here by a housing collar 6, which is likewise integrally formed with the electrode carrier 2. Said housing collar 6 and the “shoulder” (“trough wall”) of the electrode carrier 2, which shoulder runs around the trough, in this case form a wall for the electronics recess 4. The electrode carrier 2 is manufactured in this case from a thermoplastic in an injection-molding process. The proximity sensor 1 furthermore comprises a sensor electronics system 8, which is also referred to as a controller and which is arranged in the electronics recess 4. The proximity sensor 1 furthermore comprises two sensor electrodes 10, which are each formed by an electrically conductive wire (or a Litz wire comprising a plurality of such wires) and which are embedded into the electrode carrier 2 by injection molding—that is to say encapsulated with the plastic of the electrode carrier 2—and which project into the electronics recess 4 by way of an end referred to as a contact end 12.

The sensor electronics system 8 comprises a printed circuit board 14 (PCB for short) as well as a plurality of electrical component parts 16 arranged on the printed circuit board 14. One of these electrical component parts 16 may be formed in this case by a microprocessor 18. The electrical component parts 16 are also contact-connected to one another in a signal-transmitting manner by conductor tracks 20 formed on the printed circuit board 14. In order to be able to supply energy to the electrical component parts 16 and to the sensor electrodes 10, the sensor electronics system 8 may also have a connection element 22, which in the final mounted state as intended (cf. FIG. 3) is contact-connected to connection lines 24, which serve to provide energy from an on-board power supply system of a motor vehicle—into which the proximity sensor is built in the use state as intended. The connection lines 24 therefore together form an energy supply line where the necessary energy is transmitted to the sensor electronics system 8 during operation of the proximity sensor 1. At least one of the connection lines 24 serves to transmit sensor signals generated by the sensor electronics system 8 to a control electronics system of the vehicle that is superordinate to the proximity sensor 1.

The two sensor electrodes 10 are soldered by way of their contact end 12 in each case to corresponding connection areas 26 of the sensor electronics system 8 for the purpose of signal transmission. The soldering location is indicated in FIG. 2 by a solder lens 28.

FIG. 1 and FIG. 2 each illustrate a premounted state of the proximity sensor 1. In this case, the electronics recess 4 is open toward the outer side of the proximity sensor 1. A plug element 30 described in more detail below is manufactured separately from the electrode carrier 2 and therefore may not form part of the electrode carrier 2.

As illustrated in FIG. 3, the plug element 30 mentioned above may be integrally formed with a housing cover 32, by which the electronics recess 4 is sealed in a fluid-tight manner in the final mounted state as intended according to FIG. 3. In this case, the plug element 30 comprises a plug collar 34, which serves to form a fluid-tight captive connection to a mating plug of the on-board power supply system. The plug collar 34 in this case borders a plurality of plug contacts referred to as “plug pins 36” in an annularly closed manner, said plug contacts in the present exemplary embodiment according to FIG. 3 being formed in one piece with the connection lines 24. The advantage of the integration of the plug element 30 into the housing cover 32 here is that the same electrode carrier 2 may always be used as a standard component for a multiplicity of different vehicle models. The adaptation to the respective mating plug of the on-board power supply system takes place here advantageously by means of a corresponding formation of the housing cover 32.

To simplify the mounting of the proximity sensor, in an alternative exemplary embodiment, the respective sensor electrode 10 is contact-connected to the sensor electronics system 8 by means of an automatically contact-connecting contact means, in the present case specifically a clamping contact 40. The sensor electronics system 8 is embedded into the housing cover 32 by way of its printed circuit board 14, specifically pressed into the housing cover 32. In this case, a direct contact connection of the plug pins 36 to the associated conductor tracks of the printed circuit board 14 is formed. Consequently, the housing cover 32 forms a premounted unit together with the pressed-in sensor electronics system 8, said premounted unit being able to be mounted on the electrode carrier 2 as a whole. The clamping contacts 40 are formed here in such a way that the respective sensor electrode 10 is automatically (that is to say without additional actions by a person) contact-connected and held in captive manner when the sensor electronics system 8 is pushed into the electronics recess 4. Positioning of the sensor electronics system 8 as an individual component in the electronics recess 4 and soldering to the respective sensor electrode 10 may therefore be omitted.

FIG. 5 illustrates a further alternative exemplary embodiment of the proximity sensor 1. In this case, the plug element 30 may be formed separately from the housing cover 32. In this case, the connection lines 24 are fed in the form of a cable or a “cable harness” out of the electronics recess 4 through the housing cover 32 and therefore contact-connected outside of the electronics recess 4 to the plug pins 36 (not illustrated in any more detail here) of the plug element 30. To seal the connection lines 24 inside the housing cover 32, a sealing element 42 may be arranged in a passage of the housing cover 32. The plug element 30 may be clipped to the electrode carrier 2 in a manner not illustrated in any more detail. As a result, the housing cover 32 may also be formed as a standard component for a multiplicity of different vehicle models. The plug element 30 may be clipped here to a top side of the electrode carrier 2.

In a further exemplary embodiment, which builds on the exemplary embodiment according to FIG. 5, the electrode carrier 2 may have a plurality of receiving positions for the plug element 30. As a result, the plug element 30 may be fixed, specifically clipped, at different positions along the longitudinal extent of the electrode carrier 2 and therefore adapted to the installation dimensions on the cable harness of the on-board power supply system of the respective vehicle model.

The subject matter of the disclosure is not restricted to the exemplary embodiments described above. Instead, further embodiments of the disclosure may be derived from the above description by the person skilled in the art. In particular, the individual features of the disclosure and the design variants thereof described based on the different exemplary embodiments may also be combined with one another in another manner.

### LIST OF REFERENCE SIGNS

1 Proximity sensor
2 Electrode carrier
4 Electronics recess
6 Housing collar
8 Sensor electronics system
10 Sensor electrode
12 Contact end
14 Printed circuit board
16 Electrical component
18 Microprocessor
20 Conductor track
22 Connection element
24 Connection line
26 Connection area
28 Soldering lens
30 Plug element
32 Housing cover
34 Plug collar
36 Plug pin
40 Clamping contact
42 Sealing element

1. A capacitive proximity sensor for a motor vehicle, including:
wherein an electrode carrier having an integrated electronics housing is formed from plastic by injection molding,
wherein at least one capacitive sensor electrode is embedded into the electrode carrier by virtue of the capacitive sensor electrode being encapsulated with the plastic of the electrode carrier,
wherein a sensor electronics system is arranged in the electronics housing and inside the electronics housing is contact-connected to the sensor electrode,
wherein a plug element for supplying energy to the sensor electronics system is produced separately from the electrode carrier, and
wherein the sensor electronics system is contact-connected to the plug element by means of an energy supply line-.

2. (canceled)

3. The capacitive proximity sensor as claimed in claim 1,
wherein the sensor electrode passes through a wall of the electronics housing, which is integrally formed with the electrode carrier.

4. The capacitive proximity sensor of claim 3,
wherein the plug element is embodied in one piece with a cover, by way of which the electronics housing is sealed.

5. The capacitive proximity sensor as claimed in claim 4,
wherein the sensor electronics system is secured to the cover, and wherein the sensor electronics system is contact-connected to the sensor electrode by means of contact means that automatically contact-connect during mounting of the cover.

6. The capacitive proximity sensor as claimed in claim 1,
wherein the energy supply line is fed in the form of a cable through a wall element of the electronics housing to an outer side of the electrode carrier and is connected to the separately produced plug element.

7. The capacitive proximity sensor as claimed in claim 6,
wherein the plug element is secured to a surface of the electrode carrier.

8. The capacitive proximity sensor of claim 6,
wherein the electrode carrier has a multiplicity of receiving positions for the plug element.

9. A capacitive proximity sensor for a motor vehicle, comprising:
an electrode carrier having an integrated electronics housing;
at least one capacitive sensor electrode encapsulated in plastic of the electrode carrier;
a sensor electronics system arranged in the electronics housing and inside the electronics housing is contact-connected to at least one capacitive sensor electrode; and
a plug element configured to supply energy to the sensor electronics system, wherein the sensor electronics system is contact-connected to the plug element via an energy supply line.

10. The capacitive proximity sensor of claim 9, wherein the integrated electronics housing is an injection moulding housing.

11. The capacitive proximity sensor of claim 9, wherein the plug element is integrated into the cover.

12. The capacitive proximity sensor of claim 9, wherein the energy supply line is a data line.

13. The capacitive proximity sensor of claim 9, wherein the plug-in element is secured to a surface of the electrode carrier.

14. The capacitive proximity sensor of claim 9, wherein the sensor includes an energy supply line fed through a wall element of the electronics housing to an outer side of the electrode carrier, wherein the energy supply line is connected to the plug element.

15. The capacitive proximity sensor of claim 9, wherein the plug element is formed separately from the integrated electronics housing.

16. The capacitive proximity sensor of claim 9, wherein the electrode carrier includes a plurality of receiving positions for the plug element, wherein the plug element is arranged to be fixed at different positions along a longitudinal extent of the electrode carrier.

17. The capacitive proximity sensor of claim 9, wherein the plug element is one piece with a cover including a sealing element arranged in a passage of the cover.

18. The capacitive proximity sensor of claim 9, wherein the sensors electronics system includes a printed circuit board with a microprocessor and two or more electrical components contact-connected to each other via conductor tracks on the printed circuit board.

19. A method of producing a proximity sensor, comprising:
integrating an electrode carrier with an electronics housing;
forming an electronic housing via plastic injection moulding;
embedding at least one capacitive sensor electrode into the electrode carrier;
arranging a sensor electronics system in the electronics housing of the electrode carrier and inside the electronics housing, wherein the sensor electronic system is contact-connected to at least one capacitive sensor electrode; and
supplying energy to the sensor electronic systems utilizing a plug element, wherein the plug element is configured to serve for contact connection to an energy source provided by the motor vehicle, wherein the energy source is produced separately from the electrode carrier.

20. The method of claim 19, wherein the method includes securing the cover to the sensor electronics system, wherein the sensor electronics system is contact-connected to the at least one capacitive sensor electrode by a contact configured to automatically contact-connect during mounting of the cover.

21. The method of claim 19, wherein the method includes securing the plug element to a surface of the electrode carrier.
